(19) United States
(12) Patent Application Publication
(10) Pub. No.: US 2003/0156642 A1
(43) Pub. Date: Aug. 21, 2003

(54) Video coding method and corresponding encoding device

(76) Inventor: Vincent Ruol, Paris (FR)

Correspondence Address: U S Philips Corporation, Intellectual Property Department, 580 White Plains Road, Tarrytown, NY, 10591, US

(21) Appl. No.: 10/296,342

(22) PCT Filed: Mar. 26, 2002
(86) PCT No.: PCT/IB02/00997

(30) Foreign Application Priority Data
Mar. 29, 2001 (EP) 01400816.3
Nov. 30, 2001 (EP) 01403084.5

(51) Int. Cl. H04B 1/66

(52) U.S. Cl. 375/240.03

(57) ABSTRACT

The invention relates to a video coding method applied to a sequence of video frames and comprising the steps of encoding each frame in a first encoding pass with a fixed quantization step size, decoding the coded bitstream, building up for this frame a map of blocking effects, and re-encoding said frame, on the basis of modifications depending on said map, in a second encoding pass with a variable quantization step size, for generating a second output bitstream with a modified number of bits with respect to the first one. In an improved implementation, an additional normalization operation provided for avoiding some undesirable effects is carried out before the re-encoding step.

The present invention relates to a video coding method applied to a sequence of video frames divided into macroblocks themselves subdivided into blocks, said method comprising for each frame of the sequence the steps of:

(A) encoding said frame in a first encoding pass with a fixed quantization step size, for generating a first output bitstream and statistics associated to each macroblock of this frame;

(B) on the basis of said statistics, re-encoding said frame in a second encoding pass with a variable quantization step size, for generating a second output bitstream with, for each macroblock of this frame, a modified number of bits with respect to the first output bitstream.

The invention also relates to a corresponding encoding device.

The MPEG-2 standard, described for instance in the document “MPEG video coding: a basic tutorial introduction”, by S. R. Ely, BBC-RD report, 1996/3, and now widespread in the field of digital television, is already used by broadcasters via satellite or cable, ant it is soon expected to be used for digital terrestrial broadcasting. An MPEG-2 compliant video encoder generates an MPEG-2 compliant bitstream, i.e. a bitstream with six layers of syntax: sequence, group of pictures (or GOP), picture (or frame), slice, macroblock and block (each frame is divided into macroblocks, each of which comprises four luminance blocks and two chrominance blocks, each block including 8×8 pixels).

Such an encoder distinguishes between three kinds of frames I, P or B, each GOP being a set of frames that starts with an I frame and includes a given number of P and B frames. In each macroblock of an I frame, each 8x8 block undergoes a discrete cosine transform (DCT), the obtained transform coefficients are quantized (a quantization scale factor being selected for each macroblock), and the resulting quantized DCT coefficients are scanned and encoded using a variable length code (VLC). In a P frame, a decision is taken in order to code each macroblock either as an I one (as described above) or as a P one, i.e. with the help of a unidirectional prediction identified by a motion vector. The motion vector indicates, for each macroblock, the translation between its prediction in the previous frame and the macroblock itself (in the current frame), only the error between them being coded as described above for each macroblock of an I frame (and transmitted with the associated motion vector). In a B frame, a decision has also to be taken between one of the two coding techniques described above (coding of an I macroblock, or of a P macroblock, the unidirectional predictive coding being based either on a previous frame as explained above or on a subsequent frame) and a bi-directional predictive coding, according to which an error coding is similarly carried out, but only after a motion compensated prediction obtained by interpolating a backward motion compensated prediction and a forward one.

After encoding by the video encoder (with a distinct degree of compression according to the kind of frame: B frames lead to the smallest number of bits when encoded, then P frames, and I frames), the obtained bitstream is stored in an encoder output buffer, transmitted, and finally either stored in a storage medium or immediately received by the buffer of a decoder and decoded. In the encoded bitstream, the number of bits resulting from the encoding process for each of the I, P, B frames can be modified by controlling the quantizer step size used for each macroblock, this adaptive quantization resulting in fewer bits, for a large quantizer step size, than if a smaller quantizer step size is used.

It has then been proposed, in order to fulfil a required constraint at the output of such an encoder, to carry out the encoding method in such a way that the output coded bitstream is obtained only after at least two encoding passes. For instance, in the international patent application WO 99/07158 (PHF98524), the sequence of frames is encoded in a first pass, with a constant quantizer step size. The bitstream thus generated does not necessarily fulfil the required constraint, but this first pass allows to obtain statistics of the processed frame (for example, motion vectors, complexities of the frames, . . . etc). The analysis step is followed by a second pass which processes said statistics in order to modify at least the quantizer step size and, thus, to perform a more harmonious distribution of bits for each macroblock of the concerned frame.

By differently allocating the number of bits used to encode each frame (while insuring that a maximum channel rate is not exceeded so as to avoid buffer problems at the decoder side), a variable bitrate is obtained, and the MPEG-2 standard allows, in the applications as mentioned previously, a great flexibility in the bitrates at which a program can be broadcast. However, the lower the bitrate is, the more compression artifacts may occur. These artifacts, that may be spatial (blocking, ringing, corner outliers) or temporal (mosquito noise), are very annoying for the viewers.

It is therefore a first object of the invention to propose an encoding method according to which the perceptual disturbance due to said artifacts is reduced.

To this end, the invention relates to a video coding method such as defined in the introductory part of the description and which is moreover characterized in that it also comprises, between said first and second encoding passes, the steps of:

(a) decoding said first output bitstream, for generating a decoded output bitstream;

(b) in said decoded bitstream, detecting blocking artifacts for building up a map of blocking effects occurring at the internal block boundaries of all the macroblocks;

(c) modifying according to said map the statistics on the basis of which the second encoding pass is performed.

In an advantageous implementation of said coding method, said artifact detecting step comprises the sub-steps of:

associating to each of the four internal block boundaries of each macroblock a first value if no blocking effect is found on said boundary or a second value in the opposite case;

defining for each macroblock a global value G as the addition of said four values;

building for the whole frame the map of all the global values associated to the macroblocks of the processed frame;

for each macroblock, modifying said statistics according to a scaling coefficient depending on the corresponding global value.

More specifically, said first encoding pass may be provided for generating a first output bitstream and the complexity associated to each original macroblock of the processed frame, said modifying sub-step being then provided for multiplying said macroblock complexity by a scaling coefficient linearly depending on the global value corresponding to the concerned macroblock.

According to an improvement of said coding method, it may also comprise, before the re-encoding step, the additional steps of:

(a) computing a normalization factor based on the following expression:

F(norm)=X(in)/X(out)

where X(in) and X(out) are respectively the sums of the values of statistics before and after the modifications according to said map;

(b) multiplying by said normalization factor each value of statistics after said modifications.

It is also another object of the invention to propose encoding devices corresponding to the above-mentioned implementations of the coding method according to the invention.

The invention will now be described in a more detailed manner, with reference to the accompanying drawings in which:

FIG. 1 shows a conventional coding scheme with two encoding passes;

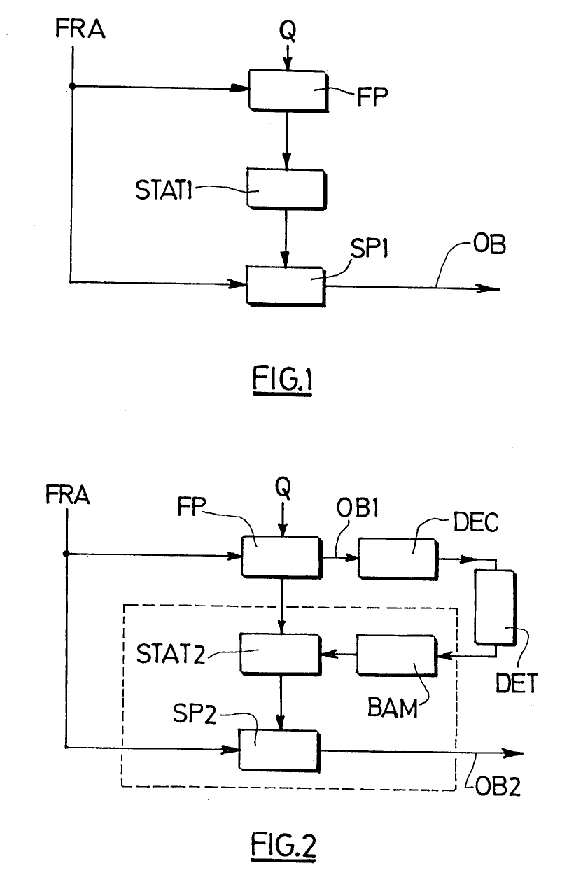

FIG. 2 illustrates a modification of said encoding scheme according to the invention;

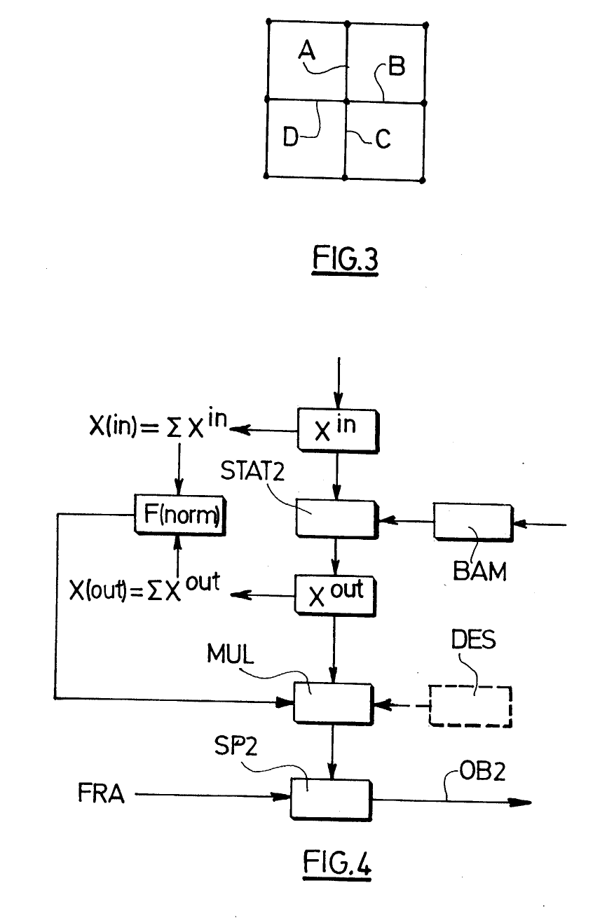

FIG. 3 shows the internal boundaries of a macroblock;

FIG. 4 illustrates another embodiment of the encoding method according to the invention;

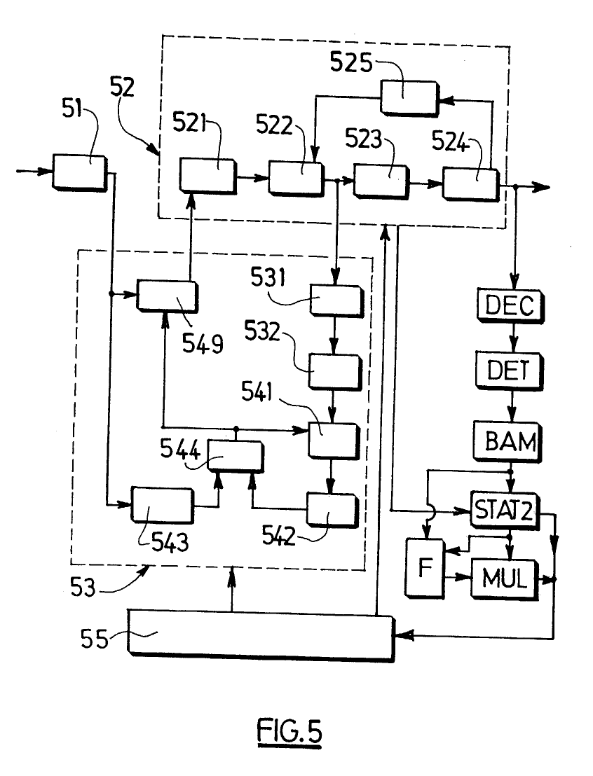

FIG. 5 depicts an example of implementation of the method of FIG. 4.

An encoding scheme such as described in the document WO 99/07158 previously cited may be schematically summarized as illustrated in FIG. 1. Each successive frame FRA is processed in the encoder, in a first pass FP during which the quantizer step size Q is constant. At the end of this first pass, some information (referenced by STAT1 in FIG. 1) is available: complexities of the processed macroblocks, motion vectors associated to each of said macroblocks, etc . . . Based on this information, a second pass SP1 leading to an output bitstream OB is carried out, during which the quantizer step size is modified for each macroblock of the frame, in order to modify in OB the bit allocation corresponding to each of said macroblocks.

According to the invention, said encoding scheme may be modified as illustrated in FIG. 2, in order to reduce the number of artifacts. The output bitstream OB1 available at the end of the first pass FP is decoded (in a decoder DEC) and the decoded bitstream is sent towards a blocking effect detector DET, described hereinunder. This detector yields a blocking artifact map BAM which is stored and used in order to modify the statistics (complexities in the present case), now referenced by STAT2 in FIG. 2. A second pass SP2, at the output of which an output bitstream OB2 is available, is then carried out, but now with a different quantizer step size for each macroblock (with respect to the second pass SP1 of FIG. 1) and with the result that the artifacts originally observed are now reduced.

The blocking effect detection operation implemented by the detector DET is carried out as follows. As previously said, a macroblock is composed of four blocks. Excluding the blocking effects between macroblocks, the blocking effects are assumed to occur inside any macroblock, at anyone of the four internal block boundaries (referenced by A, B, C, D in FIG. 3). To each of said boundaries, a value V(A), V(B), V(C), V(D) is associated: “0” if no blocking effect is found and “1” in the opposite case. For each macroblock, a global value G is then defined as G=V(A)+V(B)+V(C)+V(D), and the blocking artifact map, storing the value G for each macroblock, is constituted. For each macroblock, a first pass complexity X1, obtained by means of the first pass processing, is available. The complexity of an image or a part of an image is defined for instance in the U.S. Pat. No. 5,680,483 (PHF94510), and various documents, for instance the U.S. Pat. No. 5,929,914 (PHF95584), describe a solution for estimating a complexity and indicate the connection between such a complexity and the bitrate control of an encoder. This complexity X1 is then multiplied by a value depending on the global value G, which leads to a modified complexity: X2=X1×C(G) , where C is a coefficient depending on G, for example according to the following dependence table:

| | | | | | |
|---|---|---|---|---|---|
| G | 0 | 1 | 2 | 3 | 4 |
| C(G) | 1 | 1, 05 | 1, 1 | 1, 15 | 2 |

However, when such a method is applied to very blocky images, the whole image complexity is multiplied by the same factor. The image level regulation benefit is then lost, and the complexity weight of the image is higher in the GOPs, which disturbs the GOP level regulation.

The encoding scheme of FIG. 2 can then be improved as depicted in FIG. 4 (which illustrates a modification of the part of FIG. 2 surrounded by a dotted line), by providing in the encoder an additional step which performs a kind of normalization of the output complexity. This additional step comprises the two following operations. First, a normalization factor F(norm) is computed, based on the following expression: F(norm)=X(in)/X(out), where X(in) is the sum, for all the macroblocks of the concerned frame, of the values Xⁱⁿ received by STAT2, and X(out) is the similar sum, also for all the macroblocks, of the values X^{out} available at the output of STAT2. Second, the output value X^{out} of STAT2 is multiplied by F(norm) by means of a multiplier (MUL) provided between STAT2 and SP2.

Another embodiment of the invention, illustrated in FIG. 4, may comprise the following modification: the normalization factor is set to 1 when the input frame to be encoded is of I or P type, which allows to overweigh such frames in the GOP regulation. For that implementation, an additional decision step, referenced DES and shown in dotted line in FIG. 4, is provided.

The coding method thus described may be implemented in the video encoding device of FIG. 5, where each block corresponds to a particular function that is performed under the supervision of a controller 55. The illustrated encoding device comprises in series an input buffer 51 receiving the sequence of video frames, a subtractor 549, a discrete cosine transform (DCT) circuit 521, a quantization circuit 522, a variable length coding circuit 523, an output buffer 524, and a bitrate regulation circuit 525 allowing to modify the quantization step size in the circuit 522. The circuits 521 to 525 constitute the main elements of a coding branch 52, to which a prediction branch 53, including an inverse quantization circuit 531, an inverse DCT circuit 532 and a prediction sub-system, is associated. This prediction sub-system itself comprises an adder 541, a buffer 542, and a motion compensation circuit 544 receiving on a second input the output of a motion estimation circuit 543 (said estimation is based on an analysis of the input signals available at the output of the buffer 51). The output signals of the motion compensation circuit 544 are sent backwards to the second input of the adder 541 and towards the subtracter 549 (also receiving the output signals of the buffer 51, for sending the difference between said output signals and the output signals of the circuit 544 towards the coding branch). The output of the illustrated encoding device is sent, after the first pass FP, towards the blocking effect decoding stage DEC, the output of which is sent towards the blocking effect detector DET. The blocking artefact map BAM yielded by the detector DET is then used to modify the statistics before the second pass SP2 is carried out. The additional normalization step is then implemented by means of the circuit F , that computes F(norm), and the multiplier MUL.

The foregoing description of the preferred embodiments of the invention has been presented for purposes of illustration and description. It is not intended to be exhaustive or to limit the invention to the precise form disclosed, and obviously modifications and variations, apparent to a person skilled in the art and intended to be included within the scope of this invention, are possible in light of the above teachings. It may for example be understood that the devices described herein can be implemented in hardware, software, or a combination of hardware and software, without excluding that a single item of hardware or software can carry out several functions or that an assembly of items of hardware or software or both carry out a single function. The described methods and devices may be implemented by any type of computer system or other apparatus adapted for carrying out the methods described herein. A typical combination of hardware and software could be a general-purpose computer system with a computer program that, when loaded and executed, controls the computer system such that it carries out the methods described herein.

Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. A video coding method applied to a sequence of video frames divided into macroblocks themselves subdivided into blocks, said method comprising for each frame of the sequence the steps of:
(A) encoding said frame in a first encoding pass with a fixed quantization step size, for generating a first output bitstream and statistics associated to each macroblock of this frame;
(B) on the basis of said statistics, re-encoding said frame in a second encoding pass with a variable quantization step size, for generating a second output bitstream with for each macroblock of this frame a modified number of bits with respect to the first output bitstream;
said method being further characterized in that it also comprises, between said first and second encoding passes, the steps of:
(a) decoding said first output bitstream, for generating a decoded output bitstream;
(b) in said decoded bitstream, detecting blocking artifacts for building up a map of blocking effects occurring at the internal block boundaries of all the macroblocks;
(c) modifying according to said map the statistics on the basis of which the second encoding pass is performed.

2. A coding method according to claim 1, in which said artifact detecting step comprises the sub-steps of:
associating to each of the four internal block boundaries of each macroblock a first value if no blocking effect is found on said boundary or a second value in the opposite case;
defining for each macroblock a global value G as the addition of said four values;
building for the whole frame the map of all the global values associated to the macroblocks of the processed frame;
for each macroblock, modifying said statistics according to a scaling coefficient depending on the corresponding global value.

3. A coding method according to claim 2, in which said first encoding pass is provided for generating a first output bitstream and the complexity associated to each original macroblock of the processed frame, said modifying sub-step being then provided for multiplying said macroblock complexity by a scaling coefficient linearly depending on the global value corresponding to the concerned macroblock.

4. A device for encoding a sequence of video frames divided into macroblocks themselves subdivided into blocks, said device comprising:
(a) at least a coding branch, including in series at least a quantization circuit and a variable length circuit;
(b) a control circuit provided for controlling for each frame of the sequence the implementation of the following steps:
(A) encoding said frame in a first encoding pass with a fixed quantization step size, for generating a first output bitstream and statistics associated to each macroblock of this frame;
(B) on the basis of said statistics, re-encoding said frame in a second encoding pass with a variable quantization step size, for generating a second output bitstream with for each macroblock of this frame a modified number of bits with respect to the first output bitstream;
(C) between said first and second encoding passes, an additional step comprising the sub-steps of:
(a) decoding said first output bitstream, for generating a decoded output bitstream;
(b) in said decoded bitstream, detecting blocking artifacts for building up a map of blocking effects occurring at the internal block boundaries of all the macroblocks;
(c) modifying according to said map the statistics on the basis of which the second encoding pass is performed.

5. A coding method according to claim 1, characterized in that it also comprises, before the re-encoding step, the additional steps of:
(a) computing a normalization factor based on the following expression:
F(norm)=X(in)/X(out)
where X(in) and X(out) are respectively the sums of the values of statistics before and after the modifications according to said map;
(b) multiplying by said normalization factor each value of statistics after said modifications.

6. A video coding method according to claim 5, in which the normalization factor is set to 1 if the input frame to be encoded is of I or P type.

7. A device for encoding a sequence of video frames divided into macroblocks themselves subdivided into blocks, said device comprising:
(a) at least a coding branch, including in series at least a quantization circuit and a variable length circuit;
(b) a control circuit provided for controlling for each frame of the sequence the implementation of the following steps:
(A) encoding said frame in a first encoding pass with a fixed quantization step size, for generating a first output bitstream and statistics associated to each macroblock of this frame;
(B) decoding said first output bitstream, for generating a decoded output bitstream;
(C) in said decoded bitstream, detecting blocking artifacts, for building up a map of blocking effects occurring at the internal block boundaries of all the macroblocks;
(D) modifying the statistics according to said map;
(E) on the basis of said modified statistics, re-encoding said frame in a second encoding pass with a variable quantization step size, for generating a second output bitstream with, for each macroblock of this frame, a modified number of bits with respect to the first output bitstream;
said device being further characterized in that the control circuit is also provided for controlling for each frame of the sequence the implementation, before the re-encoding step, of the following additional steps:
(a) computing a normalization factor based on the following expression:
F(norm)=X(in)/X(out)
where X(in) and X(out) are respectively the sums of the values of statistics before and after the modifications according to said map;
(b) multiplying by said normalization factor each value of statistics after said modifications.
